(19) United States
(12) Patent Application Publication
(10) Pub. No.: US 2017/0345326 A1
(43) Pub. Date: Nov. 30, 2017

(54) PROCESS FOR USING TEST ITEM RESPONSE TIMES TO IMPROVE MEASUREMENT OF COGNITIVE ABILITY

(71) Applicant: Regents of the University of Minnesota, Minneapolis, MN (US)

(72) Inventor: Mark L. Davison, Minneapolis, MN (US)

(21) Appl. No.: 15/606,509

(22) Filed: May 26, 2017

Related U.S. Application Data
(60) Provisional application No. 62/342,605, filed on May 27, 2016.

(51) Int. Cl. G09B 7/00

(52) U.S. Cl. CPC G09B 7/00

(57) ABSTRACT

A method includes providing user interfaces from a server to present questions to a plurality of test takers. For each question and each test taker, an elapsed time is recorded and the elapsed times are used to set a boundary time between groups of response times for each question. User interfaces are then provided from the server to present the questions to an additional test taker. For each question, a response is received and a response time is determined. The response time, the received response and the boundary time of each of the questions are then used to determine a score for the additional test taker that has more precision than using the received responses alone to determine a score for the additional test taker.

### CROSS-REFERENCE TO RELATED APPLICATION

The present application is based on and claims the benefit of U.S. provisional patent application Ser. No. 62/342,605, filed May 27, 2016, the content of which is hereby incorporated by reference in its entirety.

### BACKGROUND

In electronic-based testing, a user interface on a computing device presents questions, referred to generically as items, to a test taker. The test taker interacts with the user interface to indicate a response or answer to each presented question. Based on the answers provided, the computing device generates one or more scores to differentiate the performance of one test taker from the performance of other test takers. Some testing systems are adaptive and select which questions to provide to the test taker based on previous responses that the test taker provided.

### SUMMARY

A method includes providing user interfaces from a server to present questions to a plurality of test takers. For each question and each test taker, an elapsed time is recorded and the elapsed times are used to set a boundary time between groups of response times for each question. User interfaces are then provided from the server to present the questions to an additional test taker. For each question, a response is received and a response time is determined. The response time, the received response and the boundary time of each of the questions are then used to determine a score for the additional test taker that has more precision than using the received responses alone to determine a score for the additional test taker.

In a further embodiment, a method includes receiving a response to a question and a response time. The response and the response time are then used to identify a next question to provide.

In a still further embodiment a server includes a memory and a processor. The memory holds a key file containing a single correct response to a question. The processor performs steps including receiving a boundary time separating two categories of response times; and creating an expanded key file containing a first correct response for the question and a second correct response for the question, the first correct response for the question comprising the single correct response in combination with a response time in a first of the two categories of response times and the second correct response comprising the single correct response in combination with a response time in a second of the two categories of response times.

### BRIEF DESCRIPTION OF THE DRAWINGS

FIG. 1 provides a block diagram of elements used in various embodiments.

FIG. 2 provides a flow diagram for creating and administering a test.

FIG. 3 is a block diagram of a computing device used to implement various embodiments.

### DETAILED DESCRIPTION OF ILLUSTRATIVE EMBODIMENTS

The embodiments described below provide a method for combining the accuracy and response time information into a single overall test score, although this approach also allows for two separate test scores, one for speed (overall response time score) and one for accuracy (overall accuracy score). The approach requires that items be administered by a computer so response times can be recorded.

The approach is designed for items whose responses are traditionally divided into just two categories: correct and incorrect. Such items are found on many different types of tests, for instance, tests of achievement, aptitude, job knowledge, and intelligence. Such tests are widely used in education, personnel selection in industry, professional licensing, and diagnosis of intellectual disorders. As described in the Appendix, it can be extended to items with more than two levels of accuracy: e.g. incorrect, partial credit, full credit.

### Response Categories

Several embodiments divide the responses to an item (question) into a small number of categories, but not just two, based on a combination of accuracy and response time. Only response times for correct responses are used in the categorization. There is a single category of incorrect responses but two or more categories of correct responses differing in response time. That is, there are several categories of correct response, and these correct categories differ in speed of response. In the simplest categorization, there is one category composed of incorrect responses, a second category composed of slow correct responses, and a third category composed of fast correct responses. There can be up to five categories, one incorrect category with up to four correct categories that differ in response speed. If there are three categories (one incorrect, two correct), correct responses are divided into fast and slow categories based on a median split using the median correct response time for that particular item from a calibration sample. If there are four categories (one incorrect and three correct), the correct responses are divided into 3-quantiles using the 3-quantile scores for the item's correct response time distribution from a calibration sample. Likewise, if there are five categories, the correct responses are divided into quartiles using the quartile scores from the item's correct response time distribution in an item calibration sample.

In this approach, any of several item response theories are used for scoring of the test. For purposes of applying an item response theory, the response categories for an item must be coded in some fashion, and there are several possibilities each leading to a different item response model for scoring the test. In a first embodiment, responses are coded by placing them in one of three categories: incorrect, correct but slow, and correct but fast. Thus, a single response variable xₚᵢ provides the score of person p on item i, such that xₚᵢ=0 for incorrect responses, 1 for slow correct responses, and 2 for fast correct responses. In this coding system, there is a single response variable for each item reflecting both accuracy and speed. Such a coding would most likely be used when both accuracy and speed were manifestations of the same ability dimension. An item response theory for polytomous response variables (variables having more than two categories) is used to obtain an overall ability score reflecting both speed and accuracy.

In settings where accuracy and speed reflect two different dimensions, the accuracy and speed need to be coded by different item response codes. The first code indicates whether the response is accurate, aₚᵢ=1 if correct and 0 if incorrect. Here aₚᵢ is the accuracy score for person p and item i. The second indicates response time: tₚᵢ=1 if the response is correct and fast, 0 if correct and slow, and “missing” if the item response is incorrect. Here tₚᵢ refers to the response time for person p on item i. In embodiments where there are more than two correct categories, the response time variable is either a vector or a single polytomous response time variable. Separate coding of accuracy and time is used if speed and accuracy are thought to be multidimensional. Item response theory for dichotomously scored item variables are then used to estimate an accuracy score, a speed score, and/or overall accuracy/speed score. The overall score is then considered a higher order dimension reflecting the lower order accuracy dimension and the lower order speed dimension.

An assumption underlying this approach is that response time is informative only if the item is answered correctly, and hence tₚᵢ is coded as “missing” if the response is incorrect.

In item response systems, a concept of information is used to quantify the contribution of an item to precision of measurement. In the next section, the information concept is extended so that it can be used to express the improvement in measurement precision arising when both accuracy and response time are used in scoring a test. The approach described below includes a generalization of the information concept so as to describe the contribution of response time, the combined contribution of response time and accuracy, and the increment to information provided by response time over and above accuracy. In computerized adaptive testing embodiments, the combined time/accuracy information measures is used as the basis for item selection at each step of the adaptive test.

### Using Information to Express the Contribution of Response Time

In this section, the focus is on quantifying the contribution of response time to the measurement of overall ability. Of particular interest is the use of information to quantify the contribution of response time over and above the contribution of accuracy. There are two cases to consider. The first is the situation in which there is a single polytomous item response variable, xₚᵢ reflecting both accuracy and speed. The second is the situation in which there are two separate variables, one reflecting accuracy aₚᵢ and one reflecting response time tₚᵢ.

### Case 1: Polytomous Item Variable xₚᵢ

Conceptually, information is the contribution to measurement precision made by an item category, an item, or a test. If the test is measuring a latent variable θ, the information is conditional on theta; that is, the information contributed by the item category or item or test varies as a function of θ. Information is additive in that the information of an item at θ is the sum of the information for each of its response categories, and the information of a test at θ is the sum of the information for each of its items. For xₚᵢ, with three (or more) categories, once the item is calibrated, the information for each category can be calculated from the item parameters. The total item information is the sum of the information for the several categories. The contribution of the response time information is the information associated with the highest category xₚᵢ=2. When there are more than three categories, the contribution of the response time information is the sum of the information for the categories xₚᵢ≧2. Thus, the total information for the item quantifies the total contribution of response accuracy and response time to measurement precision at θ. The contribution of response time over and above the contribution of response accuracy is given by the sum of the information for categories xₚᵢ≧2. Assuming that the polytomous model fits the data, information can be used to describe the total contribution of response accuracy and response time to measurement precision, and the increment to precision contributed by response time over and above response accuracy. Both of these contributions will vary as a function of θ. In computerized adaptive testing, the total item information can be used in selecting the next item so that at each stage of the adaptive testing, the selected item maximizes the expected information at that stage.

### Case 2: Two Item Variables Accuracy and Speed

The second case is the situation in which there are two item response variables, one for accuracy aₚᵢ and one for time tₚᵢ. This case is more complicated because the response time information will be missing for people who answer the item incorrectly.

For purpose of computing an overall ability score corresponding to a higher order dimension using item response theory, the accuracy variable aₚᵢ and the time variable tₚᵢ can (arguably) be considered two independent “items”. Once they are calibrated using an item response theory, then one can use the item parameter estimates to compute the information associated with the accuracy response variable aₚᵢ, Iₐᵢ(θ) at any given θ as well as the information associated with tₚᵢ at that same θ, Iₐᵢ(θ|aₚᵢ=1). However, the estimate of response time information Iₜᵢ(θ|aₚᵢ=1) will be the information provided by the response time variable when the item is answered correctly. If the item is answered incorrectly, the information provided by the response time variable is zero because the response time variable is missing. In other words, the information provided by the response time variable tₚᵢ is itself a variable that takes on two values, θ or Iₜᵢ(θ|aₚᵢ=1) depending on whether the item is answered correctly. The probability that the item is answered correctly is given by the item response theory for the accuracy variable:

πₐᵢ≡π(aᵢₚ=1|θₚ) (1)

The expected information provided by the response time information tₚᵢ is a weighted average of the information provided when the information is missing and the information provided when the variable is not missing:

$${I}_{ti} ( θ ) = ( 1 - {π}_{ai} ) * 0 + {π}_{ai} * {I}_{ti} ( θ \vert {a}_{pi} = 1 ) = {π}_{ai} * {I}_{ti} ( θ \vert {a}_{pi} = 1 ) \qquad ( 2 )$$

Once both the item accuracy and item response time variables are calibrated, the expected information in Equation 2 is estimated from the item parameters. The total information provided by the item is the sum of the information for the accuracy variable Iₐᵢ(θ) and the expected information for the response time variable from Equation 2 Iₜᵢ(θ). The expected information in Equation 2 Iₜᵢ(θ) is the expected contribution of response time over and above the information provided by response accuracy. Notice that the information provided by the response time variable varies as a function of θ but it will also increase as πₐᵢ increases, because as πₐᵢ increases, the missingness on variable tₚᵢ decreases. Equation 2 can be used to quantify the contribution of the response time information to measurement precision at θ. The total item information can be used to quantify the combined contribution of response accuracy and response time, and in computerized adaptive testing, it can be used for selection of the next item at each stage of the test.

As compared to traditional testing that relies solely on response accuracy, adding response time improves testing in two ways. First, given a fixed number of items, utilizing response time information yields overall ability scores with greater precision. Alternatively, in computerized adaptive testing, if testing is allowed to proceed until a pre-specified level of precision is achieved, utilizing response time information reduces the number of items required to achieve the pre-specified level of precision in the measurement of overall ability.

### Summary and Conclusions

There are two unique features of the item response coding used in the various embodiments. First, instead of coding responses into two categories, correct and incorrect, the embodiments code the responses into three or more categories using a combination of response time and response accuracy. Second, the embodiments use response time information, but only response time information of correct responses.

This approach changes the appearance of data files used in testing: the item response file, the answer key file, and the item parameter file. The item response file can be changed in one of two ways. If a single polytomous variable is used to code the data, then the response file is changed from one having only two response codes to one having three or more response codes for each item. If response time and response accuracy are coded with separate variables, the new response time variable will double the size of the item response file.

This approach also changes the appearance of the answer key. Traditional tests contain an answer key file for the accuracy variable aₚᵢ that shows the correct response for each variable. The key is used for scoring each item response as right or wrong. This new approach adds a second key file, the key file for the response time variable. It contains the median correct response time for each item from the calibration sample. The medians in this second key file are response time cut-offs used to score response times as fast or slow if the person correctly answered the item. Thus, there are two keys, one to classify answers as correct and incorrect plus a second key to classify correct answers as fast or slow. If response times are used to divide correct responses into more than two categories, then there will be additional key files needed to categorize correct response times into quantiles.

This approach also modifies the item parameter file. If the polytomous coding is used, then the parameter file will include item step values in addition to the parameters associated with dichotomous item models. If the approach uses separate coding of accuracy and response time, then the item parameter file includes item parameters for the item accuracy variables but it adds item parameters for the response time variable.

In computerized adaptive testing, this approach changes the information function used to select items at each step of the testing process. Rather than using a value representing the contribution of just response accuracy, the approach outlined here uses an information function that is a sum of accuracy and response time information. This will change the items selected at each stage. It changes the number of items administered, the precision of the scores, or both. The approach outlined here is designed to take full advantage of the fact that in computerized testing, it is feasible to record response times for each item along with information about the response itself.

When partial credit is given for partial accuracy, then two assumptions underlie the approach of the various embodiments. First, if person A is more accurate on an item than person B, person A is probably more able and should receive a higher item score. Second, if persons A and B are equally (and at least partially) accurate on the item, then the one who responds more rapidly is probably the more able and should receive the higher item score. Again, there are two cases to consider, one that involves using a single, polytomous response coding variable that combines both accuracy and response time. The second case is where there are separate accuracy and response time variables.

### Case 1: Polytomous Response Accuracy/Time Variable xₚᵢ

To illustrate how these two principles are applied, consider the situation in which there are three levels of accuracy: incorrect, partial credit, full credit. Within the partial credit, and full credit categories, there would be two or more subcategories differing in response time. For embodiments that use two response time subcategories for both partial credit and full credit, the result would be five response categories: xₚᵢ=0 if incorrect, xₚᵢ=1 if partial credit and slow, xₚᵢ=2 if partial credit and fast, xₚᵢ=3 if full credit and slow, xₚᵢ=4 if full credit and fast. In this coding scheme, if two examinees differ in accuracy, the one who is more accurate receives the higher code. If two people are equally accurate (and at least partially successful), the one who responds more rapidly may receive a higher code if their response time is less than the cut-off (the median response time for examinees in that accuracy category.)

### Case 2: Separate Accuracy and Response Time Variables

Again, consider the situation in which there are three levels of accuracy (incorrect, partial credit, full credit) and two subcategories within each level of accuracy based on response time. In this system, there would be a single accuracy variable: aₚᵢ=0 if incorrect, 1 if partial credit, and 2 if full credit. There would, however, be one response time variable for each accuracy category, and each response time variable would have two categories: fast and slow. For the partial credit (pc) category there would be a response time variable for person p and item i, t_{(pc)pi}=1 for a fast partial credit answer, 0 for a slow partial credit answer, and missing if not a partial credit answer. Similarly, there would be a response time variable for full credit (fc) answers such that t_{(fc)pi}=1 for a fast full credit answer, 0 for a slow full credit answer, and missing if not a full credit answer. Within each accuracy category, fast and slow would be determined by a median split of response times for examinees in that accuracy category.

As discussed above, one problem with electronic-based testing is that it has a limited ability to differentiate test takers from each other. In particular, testing systems that simply rely on accuracy do not provide a desired level of precision in assessing test takers.

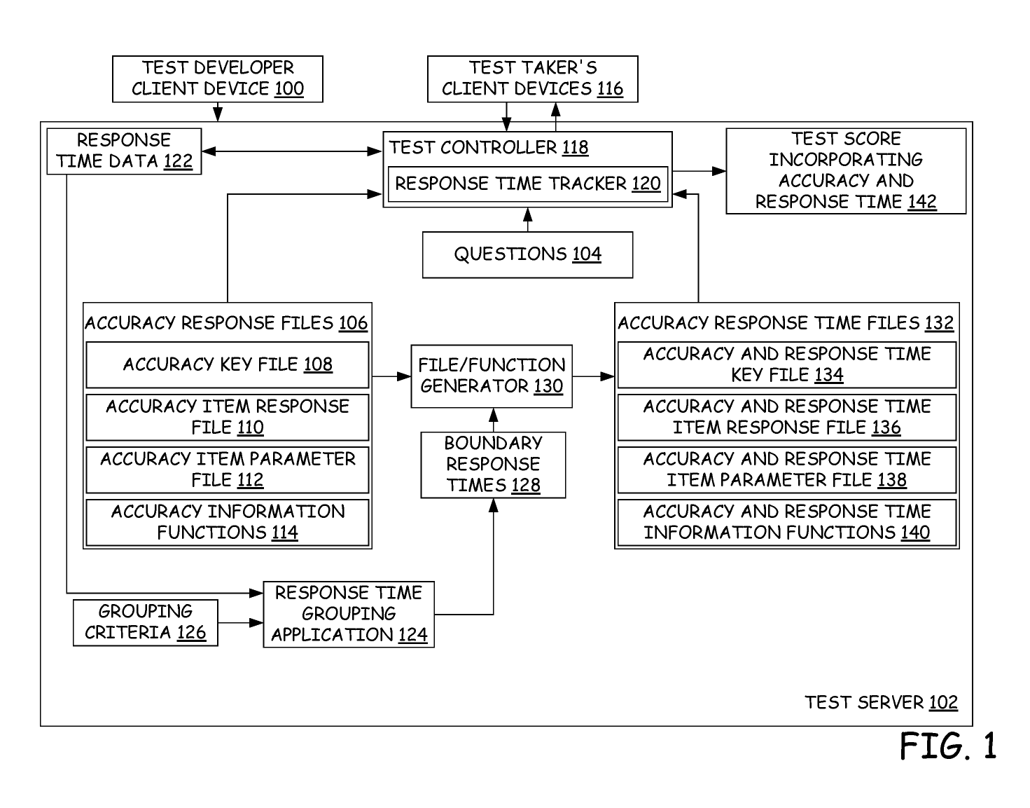

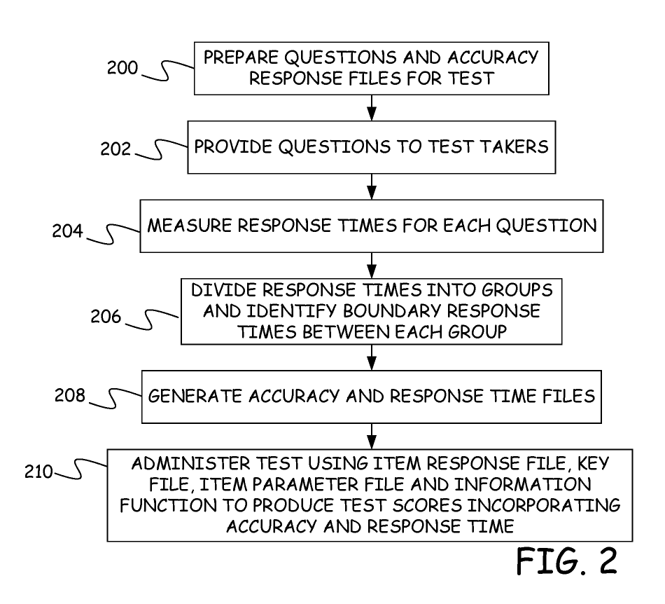

FIG. 1 provides a block diagram of elements used in several embodiments and FIG. 2 provides a flow diagram of a method of generating and administering tests that use a combination of accuracy and response time in accordance with the various embodiments. At step 200 of FIG. 2, a test developer using a test developer client device 100 interacts with a test server 102 to generate or upload questions 104 and accuracy response files 106 onto test server 102. Accuracy response files 106 can include an accuracy key file 108, an accuracy item response file 110, accuracy parameter file 112 and accuracy information functions 114. The accuracy key file 108 shows the correct response for each question 104, the accuracy item response file 110 contains response codes for each possible response in accuracy key file 108. Accuracy item parameter file 112 includes parameters associated with a dichotomous item model and accuracy information functions 114 designate paths through questions 104 based on whether the test taker answers questions correctly or incorrectly.

At step 202 of FIG. 2, questions 104 are provided by a test controller 118 to a test taker through user interfaces provided on a test taker's client device 116. Test controller 118 includes a response time tracker 120 that measures elapsed times/response times for each question at step 204. The response times for each question are stored as response time data 122 on test server 102. At step 206, a response time grouping application 124 uses response time data 122 and grouping criteria 126 to group the response times into categories and to identify boundary response times between the categories. One example of grouping criteria 126 is to divide the response times of correct answers based on the median response time of correct answers thereby forming two groups of response times. In other embodiments, the grouping criteria can include forming four response groups based on quartiles of response times for correct answers or forming five response groups based on quintiles of response times for correct answers. The response times that divide the various groups then become the boundary response times. Response time grouping application 124 forms boundary response times 128 for each question.

At step 208, a file/function generator 130 on test server 102 generates accuracy and response time files 132 based on the accuracy response files 106 and the boundary response times 128. Accuracy and response time files 132 include accuracy and response time key file 134, accuracy and response time item response file 136, accuracy and response time item parameter file 138 and accuracy and response time information functions 140.

Accuracy and response time key file 134 is created by expanding accuracy key file 108 to include additional correct responses based on the received boundary response times 128. In particular, the correct response in key file 108 is expanded such that there is a separate correct response for each group of response times represented by the boundary response times 128. In accordance with one embodiment, key file 108 is expanded by incorporating boundary response times 128 into key file 134 so that the boundary response times can be used to identify which correct answer has been given based on the test taker's response time.

Accuracy and response time item response file 136 is formed by altering accuracy item response file 110 to incorporate the response time categories. In particular, if accuracy item response file 110 includes a single polytomous variable, then the response file is changed from having only two response codes to having one response code for incorrect responses and a separate response code for the combination of the correct response and each response time group represented by boundary response times 128. If response time and response accuracy are to be coded with separate variables, a new response time variable is provided in accuracy and response time item response file 136.

Accuracy and response time item parameter file 138 is a modified version of accuracy item parameter file 112. In particular, if polytomous coding is used, then the parameter file will include item step values in addition to the parameters associated with dichotomous item models. If the approach uses separate coding of accuracy and response time, then the item parameter file includes item parameters for the item accuracy variable and for a response time variable.

Accuracy and response time information functions 140 include functions that take into account both the accuracy of the response and the response time group to determine which question 104 should be presented next to the test taker.

At step 210, test controller 118 administers the test to a test taker by providing user interfaces on one of test taker client devices 116 based on the accuracy and response time files 132 and questions 104. For each question, the response time of the test taker and the response of the test taker are recorded and are used with the boundary time(s) for the question to produce a test score incorporating accuracy and response time 142. In one particular embodiment, the test takers response is first compared to the correct response in key file 134 to determine if it is the correct response. If it is not the correct response, the score for an incorrect response is retrieved from parameter file 138 and is assigned to the response. If the test taker's response is correct, the test taker's response time is compared to the boundary times stored in key file 134 to identify which group of response times that the test taker's response time falls within. Note that by only comparing the response times to boundary times when the response is correct, the system improves the operation of the computer by not performing the comparison for incorrect responses. The score associated with a correct answer and the identified response time group in parameter file 138 is then assigned to the test taker's response. In general, different time groups will have different scores. For example, if the test taker's answer is incorrect, the answer will be given a first score, if the test taker's answer is correct and in a first group of response times, the answer will be given a second score, and if the test taker's answer is correct and in a second group of response times, the answer will be given a third score. In some embodiments, the score comprises a single value for each question. In other embodiments, the score is a score vector having an accuracy component consisting of a score associated with the answer being correct or incorrect and a response time component consisting of a score associated with which group of response times the response was assigned to when the response was correct.

In adaptive testing embodiments, a code for the answer and response time group (if any) or two separate codes, one for the answer and a second for the response time group (with a code for a “missing” response time group when the answer is incorrect), are then provided to functions 140 which uses the codes to determine a next question to provide to the test taker. Thus, the next question is selected based in part on the group of response times that the response time to the current question is assigned to.

The scores determined for the individual questions are then combined to produce a final test score for the test taker that has more precision than using the received response alone to determine a score for the test taker.

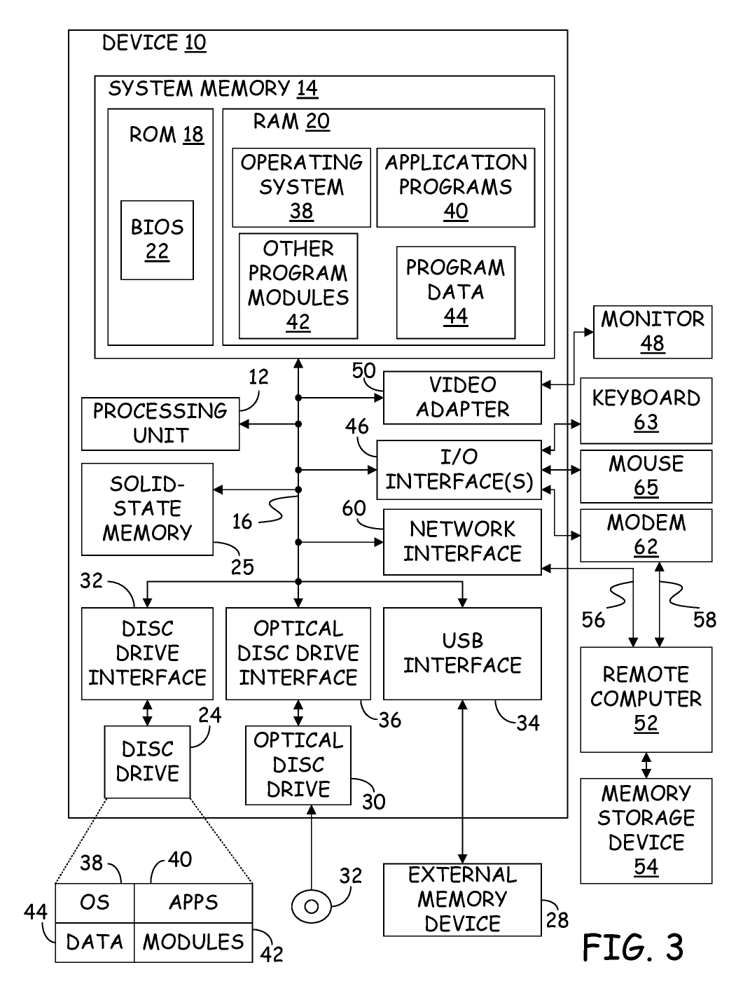

An example of a computing device 10 that can be used as a server and/or client device in the various embodiments is shown in the block diagram of FIG. 3. For example, computing device 10 may be used to perform any of the steps described above. Computing device 10 of FIG. 3 includes a processing unit (processor) 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes a hard disc drive 24, a solid state memory 25, an external memory device 28, and an optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives, solid state memory and external memory devices and their associated computer-readable media provide nonvolatile storage media for computing device 10 on which computer-executable instructions and computer-readable data structures may be stored. Other types of media that are readable by a computer may also be used in the exemplary operation environment.

A number of program modules may be stored in the drives, solid state memory 25 and RAM 20, including an operating system 38, one or more application programs 40, other program modules 42 and program data 44. For example, application programs 40 can include instructions for performing any of the steps described above. Program data can include any data used in the steps described above.

Input devices including a keyboard 63 and a mouse 65 are connected to system bus 16 through an Input/Output interface 46 that is coupled to system bus 16. Monitor 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

Computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 3. The network connections depicted in FIG. 3 include a local area network (LAN) 56 and a wide area network (WAN) 58. Such network environments are commonplace in the art.

Computing device 10 is connected to the LAN 56 through a network interface 60. Computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 3 are exemplary and other means for establishing a communications link between the computers, such as a wireless interface communications link, may be used.

Although the present invention has been described with reference to preferred embodiments, workers skilled in the art will recognize that changes may be made in form and detail without departing from the spirit and scope of the invention.

What is claimed is:

1. A method comprising:
providing user interfaces from a server to present questions to a plurality of test takers;
for each question and each test taker, recording an elapsed time;
using the elapsed times to set a boundary time between groups of response times for each question;
providing user interfaces from the server to present the questions to an additional test taker;
for each question, recording a response time and receiving a response to the question;
using the response time, the received response and the boundary time of each of the questions to determine a score for the additional test taker that has more precision than using the received responses alone to determine a score for the additional test taker.

2. The method of claim 1 wherein using the elapsed times to set a boundary time for a question comprises using the elapsed times to identify a median elapsed time of correct responses for the question and using the median elapsed time as the boundary time.

3. The method of claim 1 wherein using the elapsed times to set the boundary time for a question comprises using the elapsed times of correct responses to identify quintiles of elapsed times for the question and using an elapsed time at a boundary between two quintiles as the boundary time.

4. The method of claim 1 wherein using the response time and the boundary time to determine a score comprises assigning the response time to one of the groups of response times by comparing the response time to the boundary time.

5. The method of claim 4 wherein determining a score comprises selecting a first score if the received response is an incorrect response, selecting a second score if the received response is a correct response and the response time is assigned to a first group of response times and selecting a third score if the received response is a correct response and the response time is assigned to the second group of response times.

6. The method of claim 4 further comprising determining a next question to provide to the additional test taker based in part on the group of response times that the response time is assigned to.

7. The method of claim 1 wherein determining a score comprises determining a score vector by determining a first score based on whether the received response is a correct response or incorrect response, determining a second score based on the elapsed time and the boundary time, and combining the first score with the second score to form the score vector.

8. A method comprising:
receiving a response to a question and a response time; and
using the response and the response time to identify a next question to provide.

9. The method of claim 8 wherein using the response time to identify a next question comprises comparing the response time to a boundary time and assigning the response time to a category based on the comparison.

10. The method of claim 9 wherein comparing the response time to a boundary time further comprises comparing the response time to a plurality of boundary times.

11. The method of claim 9 wherein comparing the response time to the boundary time further comprises comparing the response time to the boundary time only when the response is a correct response for the question.

12. The method of claim 9 further comprising generating a score for the question based on the response and the category of the response time.

13. The method of claim 12 wherein generating a score for the question further comprises selecting a first score if the response is incorrect, selecting a second score if the response is correct and the response time is assigned to a first category and selecting a third score if the response is correct and the response time is assigned to a second category.

14. The method of claim 12 wherein generating a score for the question comprises generating a score vector by generating a first score based on whether the response is correct, generating a second score based on the category that the response time is assigned to, and combining the first score and the second score to form the score vector for the question.

15. The method of claim 9 further comprising receiving a plurality of responses and response times for the question and setting the boundary time based on the median response time.

16. A server comprising:
a memory holding a key file containing a single correct response to a question;
a processor performing steps comprising:
receiving a boundary time separating two categories of response times; and
creating an expanded key file containing a first correct response for the question and a second correct response for the question, the first correct response for the question comprising the single correct response in combination with a response time in a first of the two categories of response times and the second correct response comprising the single correct response in combination with a response time in a second of the two categories of response times.

17. The server of claim 16 wherein receiving the boundary time comprises receiving a plurality of response times for the question, grouping the received response times into at least two groups and setting a response time between two of the groups as the boundary time.

18. The server of claim 16 further comprising using the expanded key to score a response to the question.

19. The server of claim 18 wherein using the expanded key to score the response to the question comprises assigning a first score if the response does not match the single correct response, assigning a second score if the response and response time match the first correct response, and assigning a third score if the response and response time match the second correct response.

20. The server of claim 18 wherein using the expanded key to score the response to the question comprises providing a first score based on whether the response matches the single correct response, providing a second score based on whether the response time is in the first of the two categories or the second of the two categories.
